(19) United States
(12) Patent Application Publication
(10) Pub. No.: US 2015/0258938 A1
(43) Pub. Date: Sep. 17, 2015

(54) REAR-VIEW MIRROR ASSEMBLY

(71) Applicant: Wen-Pin TSENG, Changhua County (TW)

(72) Inventor: Wen-Pin TSENG, Changhua County (TW)

(21) Appl. No.: 14/206,634

(22) Filed: Mar. 12, 2014

(51) Int. Cl. B60R 1/08; B60R 1/06

(52) U.S. Cl. CPC B60R 1/081; B60R 1/06

(57) ABSTRACT

A rear-view mirror assembly is formed of a base, a main mirror, and an auxiliary mirror. The main and auxiliary mirrors are mounted to the base. The base includes a positioning portion and at least one guiding portion located an external side of the positioning portion. The auxiliary mirror includes at least one guided portion and an assembly portion having a complementary shape with that of the positioning portion for making the auxiliary mirror be rotatably installed to the positioning portion. In light of this, the driver can easily adjust an inclined angle between the main and auxiliary mirrors to lead to the preferable field of vision of the main mirror to avoid the blind spots of the drive for more driving safety.

### BACKGROUND OF THE INVENTION

1. Field of the Invention

The present invention relates generally to a rear-view mirror mounted to an external side of a car and more particularly, to a rear-view mirror assembly having two mirrors, one of which can be adjusted independently for an inclined angle between this mirror and the other for better driving field of vision.

2. Description of the Related Art

As the modern society paces faster and faster, a vehicle has become the necessary transportation for the modern people and the performance of the vehicle has been being changed with each passing day. As for the driver, a rear-view mirror is a very important gear for providing rear field of vision. In particularly, the image provided by the rear-view mirror mounted to an external side of the vehicle is even what the driver needs to pay more attention while overtaking another vehicle or backing the vehicle up.

However, a variety of electronic apparatuses for indicating blind spots though have been developed as an auxiliary tool, but such electronic apparatuses are generally expensive and operationally worse than the traditional rear-view mirror according to the driver's custom. The conventional rear-view mirror has though been designed to completely overcome the blind spots of the field of vision, e.g. a circular convex mirror or an inclined auxiliary mirror is mounted to a main mirror, but such design usually fails to allow the driver to adjust the field of vision as per his or her need. For this reason, the conventional rear-view mirror is limited in function to need further improvement.

### SUMMARY OF THE INVENTION

The primary objective of the present invention is to provide a rear-view mirror assembly, one mirror of which can be independently adjusted relative to the other to allow the driver to properly adjust his or her driving field of vision.

The foregoing objective of the present invention is attained by the rear-view mirror assembly formed of a base, a main mirror, and an auxiliary mirror. The main and auxiliary mirrors are mounted to the base. The base includes a positioning portion. The auxiliary mirror includes an assembly portion having a complementary shape with that of the positioning portion for making the auxiliary mirror be rotatably installed to the positioning portion. In light of this, the driver can easily apply a force to the auxiliary mirror to make the auxiliary mirror rotate relative to the base for adjusting an inclined angle between the main and auxiliary mirrors. In this way, the auxiliary mirror can provide an auxiliary field of vision different from the field of vision of the main mirror to decrease the blind spots of the drive for more driving safety.

### BRIEF DESCRIPTION OF THE DRAWINGS

FIG. 1 is a perspective view of a first preferred embodiment of the present invention.

FIG. 2 is a partially exploded view of the first preferred embodiment of the present invention.

FIG. 3 is a sectional view taken along a line 3-3 indicated in FIG. 1.

FIG. 4 is a perspective view of a second preferred embodiment of the present invention.

FIG. 5 is a partially exploded view of the second preferred embodiment of the present invention.

### DETAILED DESCRIPTION OF PREFERRED EMBODIMENTS

Structural features and desired effects of the present invention will become more fully understood by reference to two preferred embodiments given hereunder. However, it is to be understood that these embodiments are given by way of illustration only, thus are not limitative of the claim scope of the present invention.

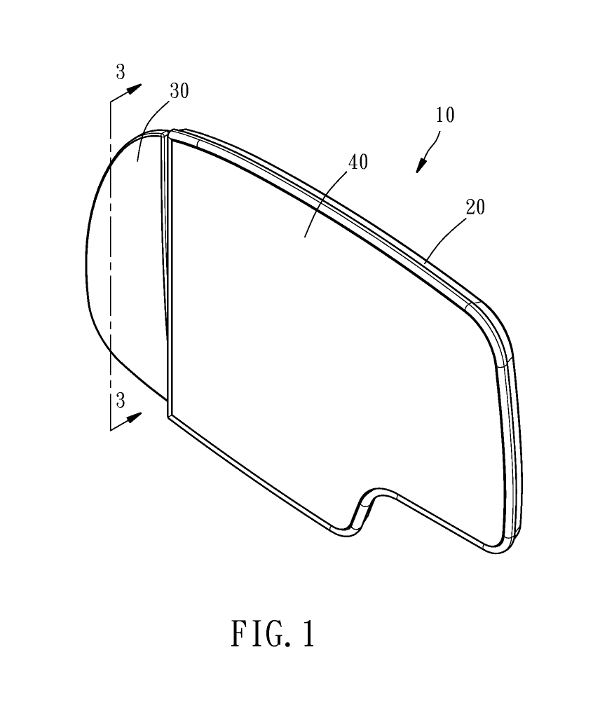

Referring to FIG. 1, a rear-view assembly 10 constructed according to a first preferred embodiment is formed of a base 20, a main mirror 30, and an auxiliary mirror 40. The main mirror 30 and the auxiliary mirror 40 are installed to the base 20. The auxiliary mirror 40 is a flat mirror or a convex mirror and rotatable relative to the base 10, so an inclined angle between the main mirror 30 and the auxiliary mirror 40 can be further adjusted. The detailed descriptions and operations of these elements as well as their interrelations are recited in the respective paragraphs as follows.

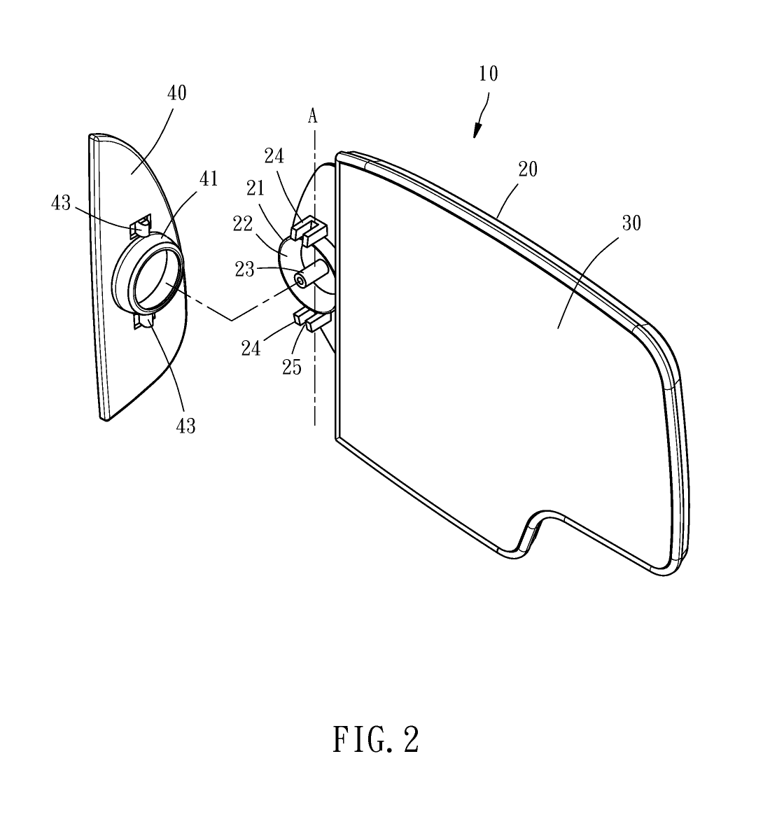

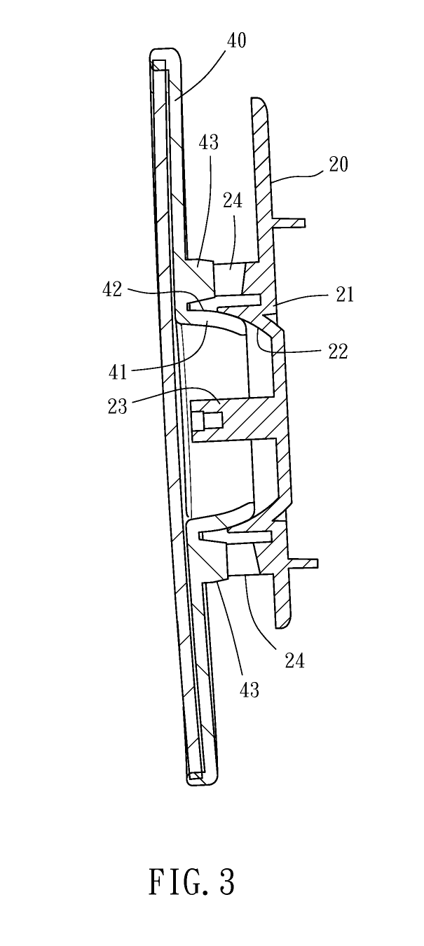

Referring to FIGS. 2 and 3, the base 20 includes a circular concavity serving as the positioning portion 21. The positioning portion 21 includes a limiting post 23 protruding toward the auxiliary mirror 40 from a bottom side thereof. The base 20 further includes two guiding portions 24 mounted to an external side of the positioning portion 21. The guiding portions 24 are arranged on the same imaginary straight line A and each are provided with a gap 25 formed on a top side thereof.

The auxiliary mirror 40 includes an assembly portion 41 corresponding to the positioning portion 21 and having a complementary shape with that of the positioning portion 21. In this embodiment, the assembly portion 41 is a ring-shaped convexity inserted into the positioning portion 21 and the assembly 51 includes an external arc-shaped surface 42 stopped against the internal arc-shaped surface 22, so the auxiliary mirror 40 is rotatably mounted to the base 20. The auxiliary mirror 40 includes two posts and corresponding to the guiding portions 24 and serving as guided portions 43. When the auxiliary mirror 40 is installed to the base 20, the guiding portions 43 are inserted into the gaps 25. Thus, the auxiliary mirror 40 is guided by the guiding portions 24 to be rotatable on an imaginary plane passing through the imaginary straight line A.

Referring to FIG. 3 again, a rotary angle of the auxiliary mirror 40 is limited by the limiting post 23. In other words, when the rotary angle of the auxiliary mirror 40 reach the maximum, a backside of the auxiliary mirror 40 contacts a top side of the limiting post 23.

It is worth mentioning that the guiding portions 24 and the limiting posts 23 are provided for guiding or limiting the action of the auxiliary mirror 40 and in fact, the auxiliary mirror 40 only needs to be rotatable relative to the base 20 successfully. In addition, the positioning portion 21 and the assembly portion 41 are not structurally limited to the shapes indicated in this preferred embodiment, as an example only, and can be changed, e.g. change of locations of the concavity and the ring-shaped convexity, as long as the concavity and the ring-shaped convexity are complementary with each other in shape.

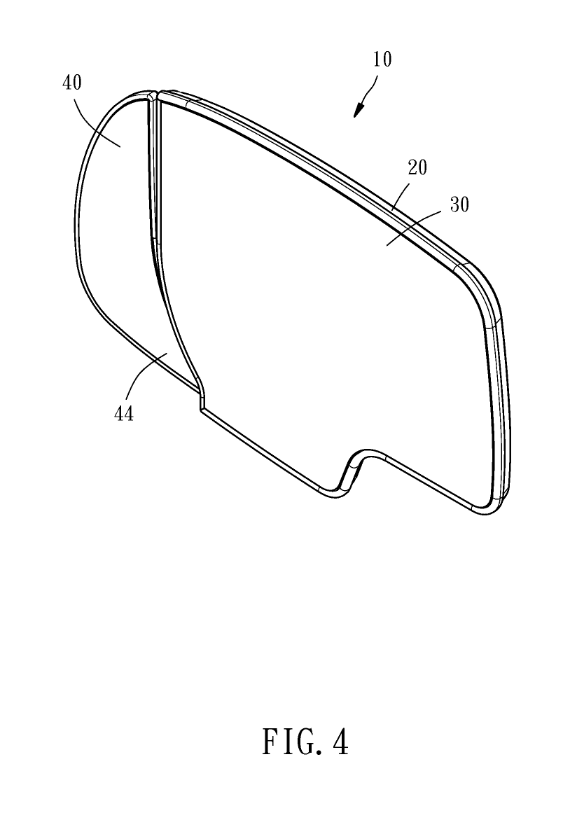

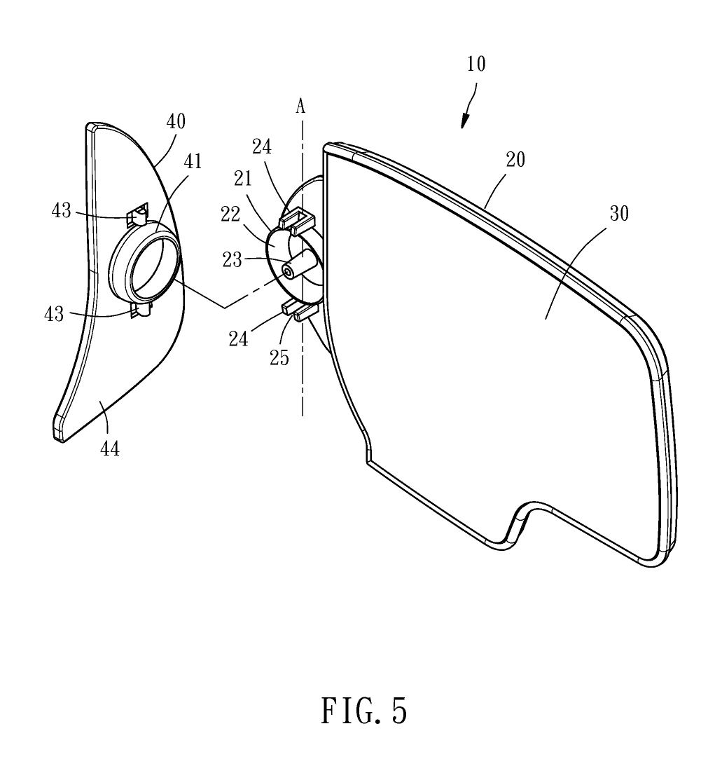

Referring to FIGS. 4 and 5, a rear-view mirror assembly 10 constructed according to a second preferred embodiment of the present invention is similar to that of the first preferred embodiment, having the following difference. The auxiliary mirror 40 of the second preferred embodiment includes a horny extended part 44 extending toward the main mirror 20 from a lower half part thereof for further enlarging the field of vision of the auxiliary mirror 40.

In conclusion, the rear-view mirror assembly of the present invention further allows the driver to adjust the inclined angle of the auxiliary mirror relative to the main mirror as per his or her need, after adjusting the main mirror, to make the main and auxiliary mirrors provide two fields of vision at the same time. In this way, the driving blind spot can be reduced to enhance the driving safety.

What is claimed is:

1. A rear-view mirror assembly comprising a base, a main mirror, and an auxiliary mirror, the main and auxiliary mirrors being mounted to the base, rear-view mirror assembly being characterized in that the base has a positioning portion and the auxiliary mirror has an assembly portion having a complimentary shape with that of the positioning portion, whereby the auxiliary mirror is rotatably installed to the positioning portion.

2. The rear-view mirror assembly as defined in claim 1, wherein the positioning portion is a concavity and comprises an arc-shaped surface formed at an internal side thereof; the assembly portion is a convexity and includes an external arc-shaped surface formed at an external side thereof, the convexity being able to be received in the concavity and the external arc-shaped surface abutting against the internal arc-shaped surface.

3. The rear-view mirror assembly as defined in claim 2, wherein the concavity is circular and the convexity is ring-shaped.

4. The rear-view mirror assembly as defined in claim 1, wherein the base comprises at least one guiding portion located at an external side of the positioning portion; the auxiliary mirror comprises at least one guided portion connected with the at least one guiding portion.

5. The rear-view mirror assembly as defined in claim 4, wherein the at least one guiding portion comprises a gap formed at a top side thereof and the at least one guided portion is connected with the at least one guiding portion.

6. The rear-view mirror assembly as defined in claim 5, wherein each of the at least one guiding portion and the at least one guided portion is one in number and arranged on the same straight line.

7. The rear-view mirror assembly as defined in claim 6, wherein the concavity comprises a limiting post protruding toward the auxiliary mirror from a bottom side of the concavity.

8. The rear-view mirror assembly as defined in claim 1, wherein the auxiliary mirror is a flat mirror or a convex mirror.

9. The rear-view mirror assembly as defined in claim 8, wherein the auxiliary mirror comprises an extended part extending toward the main mirror.

10. The rear-view mirror assembly as defined in claim 9, wherein the extended part is a horny lower half part of the auxiliary mirror.
